(19) United States
(12) Patent Application Publication
(10) Pub. No.: US 2008/0115359 A1
(43) Pub. Date: May 22, 2008

(54) High Resistance Heater Material for A Micro-Fluid Ejection Head

(76) Inventors: Yimin Guan, Lexington, KY (US); Carl Edmond Sullivan, Stamping Ground, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/561,993

(22) Filed: Nov. 21, 2006

(51) Int. Cl. B23P 17/00; B41J 2/05

(52) U.S. Cl. 29/890.1; 347/62

(57) ABSTRACT

A thin film heater for a micro-fluid ejection head and methods for making the thin film heater and for making micro-fluid ejection heads containing the thin film heater. In one embodiment, a thin film heater comprises a tantalum-aluminum-nitride thin film material having a nano-crystalline structure consisting essentially of AlN, TaN, and TaAl alloys. A sheet resistance of the thin film heater ranges from about 100 to about 600 ohms per square. The thin film heater has a thickness ranging from about 100 to about 800 Angstroms and exhibits improved aluminum/silicon diffusion barrier properties.

### TECHNICAL FIELD

The disclosure relates to micro-fluid ejection devices and in a particular exemplary embodiment to thin film heater resistors having high resistance and high film uniformity.

### BACKGROUND AND SUMMARY

Micro-fluid ejection devices such as ink jet printers continue to experience wide acceptance as economical replacements for laser printers. Micro-fluid ejection devices also are finding wide application in other fields such as in the medical, chemical, and mechanical fields. As the capabilities of micro-fluid ejection devices are increased to provide higher ejection rates, the ejection heads, which are the primary components of micro-fluid devices, continue to evolve and become more complex.

For example, ejection heads having a silicon substrate and aluminum conductive layers may require a diffusion barrier to prevent Al/Si inter-diffusion at an interface between the aluminum layer and silicon substrate. In the case where Al contacts with the Si substrate with no barrier layer, rapid Al/Si inter-diffusion may occur at elevated temperatures (e.g., temperatures >400° C.) During Al/Si inter-diffusion, Si will quickly diffuse into Al through the grain boundaries. Simultaneously, Al will fill up the Si vacancies and form Al spikes. If the Al spikes go deep enough into the silicon, the Al spikes may short reversely biased p/n junctions in the Si device and cause device leakage.

Three types of barrier layers are typically used in the semiconductor fabrication industry to prevent Al/Si inter-diffusion, i.e., stuffed barrier layers, passive compound barrier layers, and sacrificial barrier layers. Stuffed barrier layers rely on the segregation of impurities along otherwise rapid diffusion paths such as grain boundaries to block inter-diffusion of atoms. Passive compound barrier layers exhibit chemical inertness as well as low diffusivity to both Al and Si. As a result, there is negligible inter-diffusion between Al/Si diffusion couple with a passive compound barrier layer. A sacrificial barrier consumes itself by reacting with both sides of the Al/Si diffusion couple so that Al/Si inter-diffusion is impeded.

Providing a barrier layer to prevent Al/Si diffusion may increase the number of process steps and the complexity of a micro-fluid ejection head. Accordingly, there continues to be a need for methods and apparatus for reducing the number of process steps required for fabricating ejection heads while at the same time providing suitable Al/Si barrier layers.

In accordance with a first aspect, one exemplary embodiment of the disclosure provides a thin film heater for a micro-fluid ejection head. The thin film heater is a tantalum-aluminum-nitride thin film material having a nano-crystalline structure consisting essentially of AlN, TaN, and TaAl alloys. A sheet resistance of the thin film heater ranges from about 100 to about 600 ohms per square. The thin film heater has a thickness ranging from about 100 to about 800 Angstroms. One advantage of such a thin film heater can include improved aluminum/silicon diffusion barrier properties.

In another exemplary embodiment there is provided a method for making a micro-fluid ejection head for a micro-fluid ejection device. The method includes depositing a thin film resistive layer adjacent to a surface of a substrate to provide a plurality of thin film heaters. The thin film resistive layer is a tantalum-aluminum-nitride thin film material having a nano-crystalline structure made of AlN, TaN, and TaAl alloys. The thin film material has a sheet resistance ranging from about 100 to about 600 ohms per square, a thickness ranging from about 100 to about 800 Angstroms, and a bulk resistivity of from about 1000 to about 4000 μohm·cm. Anode and cathode conductors are defined adjacent to the thin film heaters.

In yet another exemplary embodiment, there is provided a method for making a high resistance thin film resistor for a micro-fluid ejection head. According to the method a substrate is heated to a temperature ranging from above about room temperature to about 350° C. A tantalum aluminum alloy target containing from about 50 to about 60 atomic % tantalum and from about 40 to about 50 atomic % aluminum is reactively sputtered adjacent to a surface of the substrate. During the sputtering, a flow of nitrogen gas and a flow of argon gas having a flow rate ratio of nitrogen to argon ranging from about 0.1 to about 0.5 is used. The sputtering is terminated when the thin film resistor deposited adjacent to the substrate has a thickness ranging from about 100 to about 800 Angstroms. The thin film resistor comprises a TaAlN alloy containing from about 30 to about 50 at. % tantalum, from about 10 to about 40 at. % aluminum and from about 30 to about 50 at. % nitrogen, and the resistor has a bulk sheet resistance uniformity with respect to the substrate of less than about 8%.

An advantage of the exemplary embodiments is that the exemplary embodiments may provide improved micro-fluid ejection heads having thermal ejection heaters that have lower energy requirements and also provide suitable barriers layers for preventing Al/Si inter-diffusion. The heater resistors described herein may also have increase resistance which enables the resistors to be driven with smaller drive transistors thereby reducing the substrate area required for active devices to drive the heater resistors. A reduction in the area required for active devices to drive the heaters enables the use of a smaller substrate, thereby reducing the cost of the ejection heads. In addition, high resistance heaters may be driven with less current thereby reducing the variation of heater energy caused by parasitic resistance. An advantage of the exemplary production methods for making the thin film heater resistors described herein is that the thin film heater resistors may have a substantially uniform sheet resistance over the surface of a substrate on which they are deposited.

### BRIEF DESCRIPTION OF THE DRAWINGS

Further advantages of the exemplary embodiments may become apparent by reference to the detailed description of the exemplary embodiments when considered in conjunction with the following drawings illustrating one or more non-limiting aspects of thereof, wherein like reference characters designate like or similar elements throughout the several drawings as follows:

FIG. 1 is a micro-fluid ejection device cartridge, not to scale, containing a micro-fluid ejection head according to an exemplary embodiment;

FIG. 2 is a perspective view of an ink jet printer and ink cartridge containing a micro-fluid ejection head according to an exemplary embodiment;

FIG. 3 is a cross-sectional view, not to scale of a portion of a micro-fluid ejection head according to an exemplary embodiment;

FIG. 4 is a plan view not to scale of a typical layout on a substrate for a micro-fluid ejection head according to an exemplary embodiment;

FIG. 5 is a plan view, not to scale of a portion of an active area of a micro-fluid ejection head according to an exemplary embodiment;

FIG. 6 is an electromicrograph cross-sectional view of an aluminum layer and silicon layer illustrating aluminum spiking of the silicon layer;

FIG. 7 is an electromicrograph cross-sectional view of an aluminum layer and silicon layer illustrating aluminum with a barrier layer according to an exemplary embodiment; and

FIG. 8 is a cross-sectional view of a heater stack area of a micro-fluid ejection head according to an exemplary embodiment.

### DESCRIPTION OF THE EXEMPLARY EMBODIMENTS

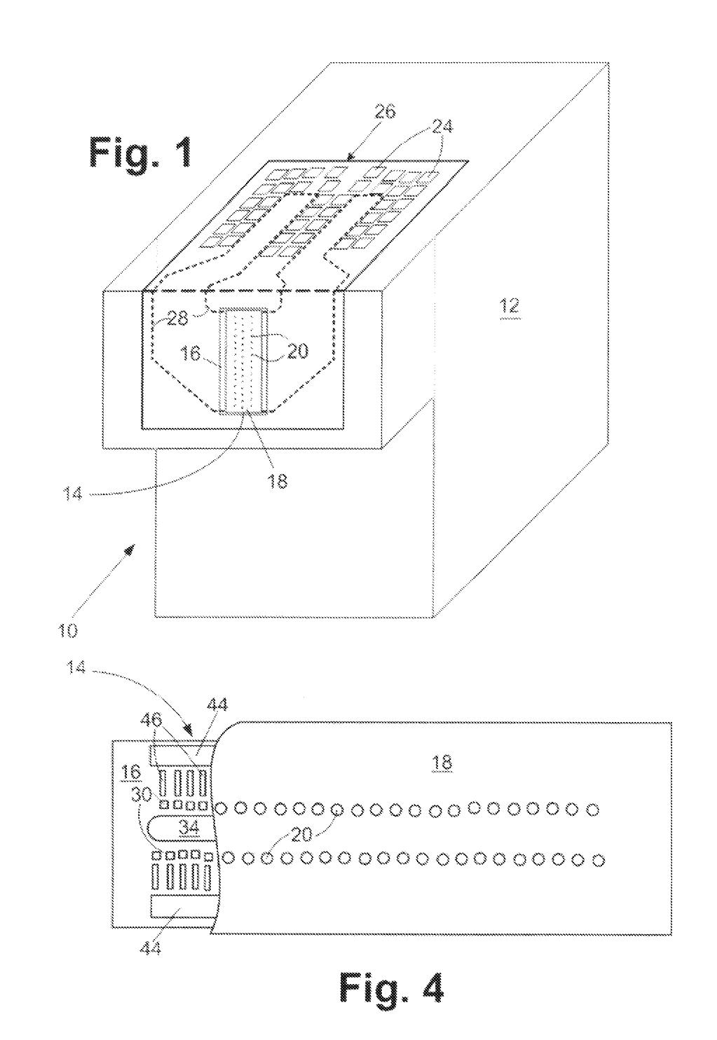

With reference to FIG. 1, a fluid cartridge 10 for a micro-fluid ejection device is illustrated. The cartridge 10 includes a cartridge body 12 for supplying a fluid to a micro-fluid ejection head 14. The fluid may be contained in a storage area in the cartridge body 12 or may be supplied from a remote source to the cartridge body.

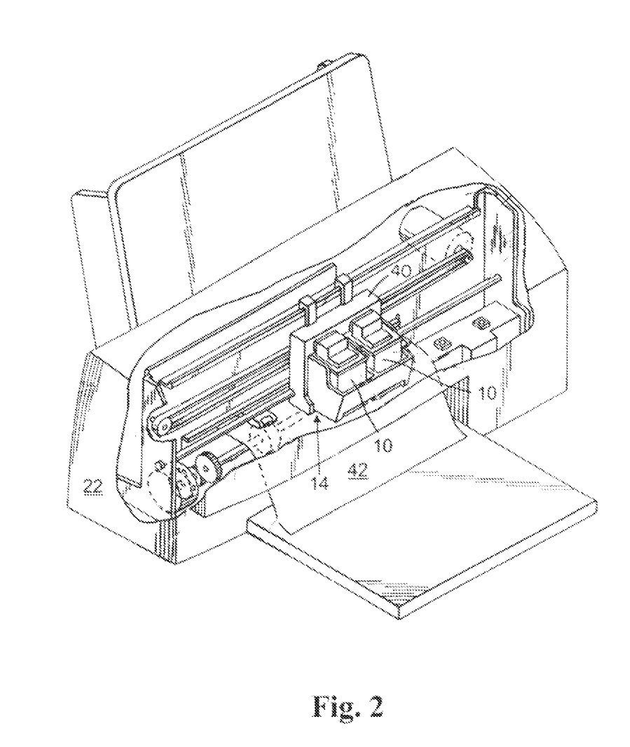

The micro-fluid ejection head 14 includes a substrate 16 and a nozzle plate 18 containing nozzles 20. In some embodiments, the cartridge can be removably attached to a micro-fluid ejection device such as an ink jet printer 22 (FIG. 2). Accordingly, electrical contacts 24 are provided on a flexible circuit 26 for electrically connecting the cartridge 10 to the micro-fluid ejection device 22. The flexible circuit 26 includes electrical traces 28 that are connected to the substrate 16 of the micro-fluid ejection head 14.

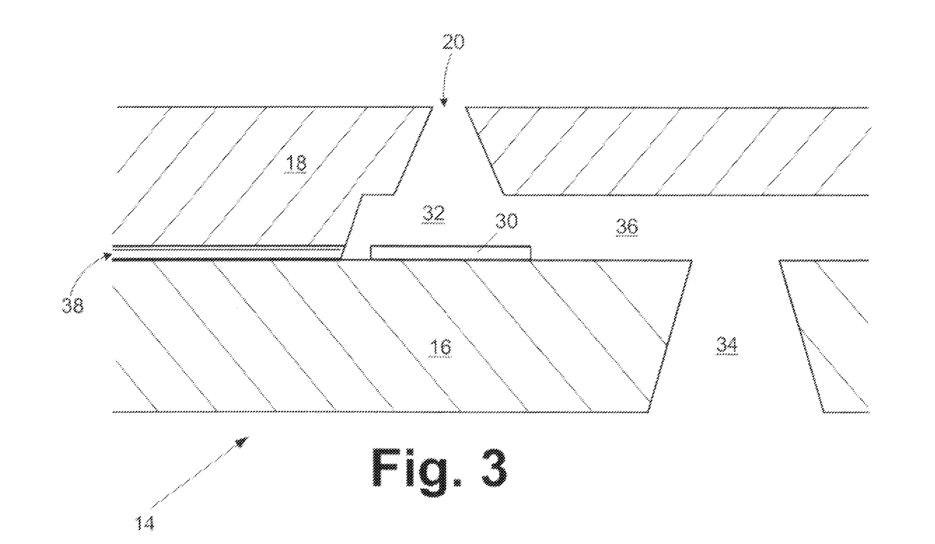

An enlarged cross-sectional view, not to scale, of a portion of the micro-fluid ejection head 14 is illustrated in FIG. 3. The micro-fluid ejection head 14 contains a thin film heater 30 as a fluid ejection actuator for heating the fluid in a fluid chamber 32 between the substrate 16 and a nozzle hole 20. The thin film heaters 30, described in more detail below, are thin film heater resistors which, according to an exemplary embodiment, are comprised of an alloy of tantalum, aluminum, nitrogen.

Fluid is provided to the fluid chamber 32 through an opening or slot 34 in the substrate 16 and through a fluid channel 36 connecting the slot 34 with the fluid chamber 32. The nozzle plate 18 is adhesively attached to the substrate 16 as by adhesive layer 38. As depicted in FIG. 3, the flow features including the fluid chamber 32 and fluid channel 36 may be formed in the nozzle plate 18. However, the flow features may be provided in a separate thick film layer and a nozzle plate containing only nozzle holes may be attached to the thick film layer. In an exemplary embodiment, the micro-fluid ejection head 14 is a thermal ink jet printhead. However, the exemplary embodiments described herein are not intended to be limited to ink jet printheads as other fluids, other than ink, may be ejected with a micro-fluid ejection device according to the exemplary embodiments.

Referring again to FIG. 2, the fluid ejection device may be an ink jet printer 22. The printer 22 includes a carriage 40 for holding one or more cartridges 10 and for moving the cartridges 10 over a media 42 such as paper for depositing a fluid from the cartridges 10 onto the media 42. The contacts 24 on the cartridge mate with contacts on the carriage 40 for providing electrical connection between the printer 22 and the cartridge 10. Microcontrollers in the printer 22 control the movement of the carriage 40 across the media 42 and convert analog and/or digital inputs from an external device such as a computer for controlling the operation of the printer 22. Ejection of fluid from the micro-fluid ejection head 14 is controlled by a logic circuit on the fluid ejection head 14 in conjunction with the controller in the printer 22.

A plan view, not to scale of the micro-fluid ejection head 14 is illustrated in FIG. 4. The micro-fluid ejection head 14 includes a substrate 16 and a nozzle plate 18 attached to the substrate 16. A layout of device areas of the substrate 16 is shown providing predetermined locations for logic circuitry 44, driver transistors 46, and heater resistors 30. As shown in FIG. 4, the substrate 16 may include a single slot 34 for providing fluid such as ink to the heaters 30 that are disposed on both sides of the slot 34. However, the exemplary embodiments are not limited to a substrate 16 having a single slot 34 or to heaters 30 disposed on both sides of the slot 34. Other substrates according to the exemplary embodiments may include multiple slots with heaters disposed on one or both sides of the slots. In another exemplary embodiment, fluid may flow around edges of the substrate 16 to the heaters rather than flowing through slots 34 in the substrate. In a further exemplary embodiment, the substrate 16 may include multiples holes or openings, one each for one or more heaters rather than slots 34 in the substrate 16. The nozzle plate 18, made of an ink resistant material such as polyimide, is attached to the substrate 16.

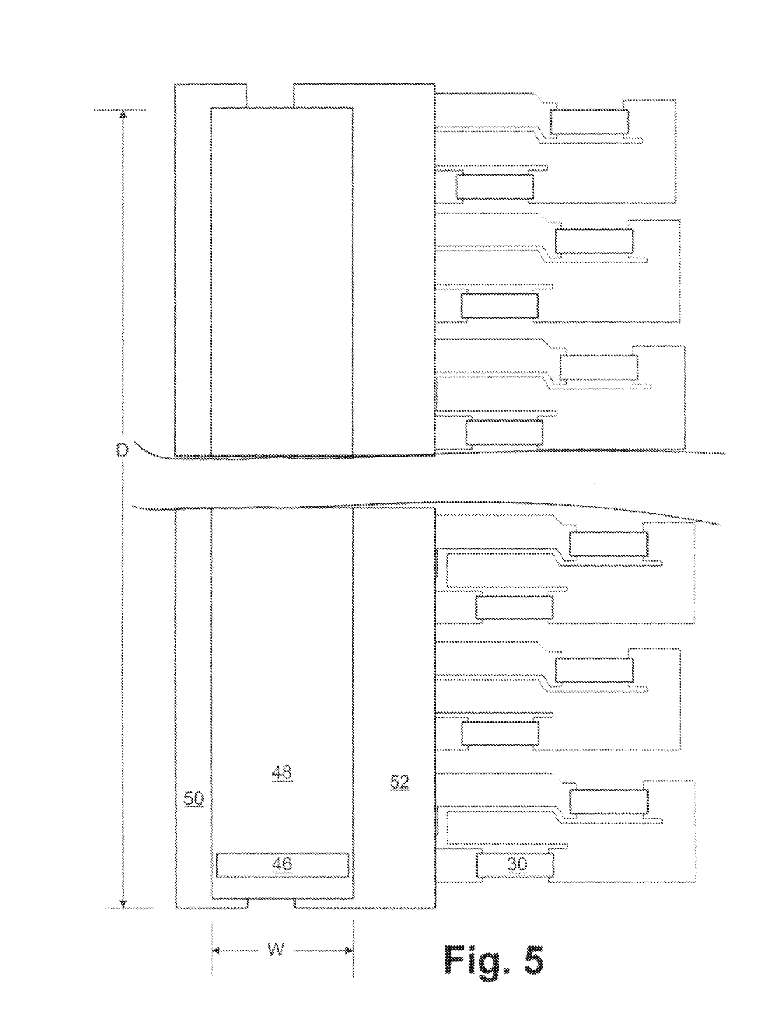

An active area 48 of the substrate 16 for the driver transistors 46 is illustrated in detail in a plan view of the active area 48 in FIG. 5. This figure represents a portion of a typical heater array and active area 48. A ground bus 50 and a power bus 52 are provided to provide power to the devices in the active area 46 and to the heaters 30.

In order to reduce the size of the substrate 16 required for the micro-fluid ejection head 14, the driver transistor 46 active area width indicated by (W) is reduced. In an exemplary embodiment, the active area 48 of the substrate 16 may have a width dimension W ranging from about 100 to about 400 microns and an overall length dimension D ranging from about 6,300 microns to about 26,000 microns. The driver transistors 46 may be provided at a pitch P ranging from about 10 microns to about 84 microns.

In one exemplary embodiment, the active area 48 of a single driver transistor 46 on the semiconductor substrate 16 may have an active area width (W) ranging from about 100 to less than about 400 microns and an active area 48 of less than about 15,000 μm². The smaller active area 48 may be achieved by use of driver transistors 46 having gate lengths and channel lengths ranging from about 0.8 to less than about 3 microns.

However, the resistance of the driver transistor 46 is proportional to its width W. The use of smaller driver transistors 46 increases the resistance of the driver transistor 46. Thus, in order to maintain a constant ratio between the heater resistance and the driver transistor resistance, the resistance of the heater 30 must be increased proportionately. A benefit of a higher resistance heater 30 is that the heater requires less driving current. In combination with other features of the heater 30, the exemplary embodiments may provide an ejection head 14 having higher efficiency and an ejection head 14 capable of higher frequency operation.

One approach to providing a high resistance heater is to use a higher aspect ratio heater, that is, a heater having a length significantly greater than its width. However, such high aspect ratio design tends to trap air in the fluid chamber 32. Another approach to providing a high resistance heater 30 is to provide a heater made from a thin film material having a higher sheet resistance. Once such material is TaN. However, relatively thin TaN has inadequate aluminum barrier characteristics thereby making it less suitable than other materials for use in micro-fluid ejection devices. Aluminum barrier characteristics are particularly important when the resistive layer is extended over and deposited in a contact area for an adjacent transistor device. Without a protective layer, for example TiW, in the contact area, the thin film TaN is insufficient to prevent diffusion between aluminum deposited as the contact metal and the underlying silicon substrate.

Accordingly, a suitable heater may be a thin film heater 30 made of an alloy of tantalum, aluminum, and nitrogen. In contrast to the thin film TaN heater described above, a thin film heater 30 made according an exemplary embodiment may also provide a suitable barrier layer in an adjacent transistor contact area without the use of an intermediate barrier layer between the aluminum contact and the substrate, as well as provide a higher resistance heater 30.

The thin film heater 30 may be formed by a reactive sputtering process wherein a tantalum/aluminum alloy target is sputtered adjacent to (e.g., onto) the substrate 16 in the presence of nitrogen and argon gas. The tantalum/aluminum alloy target may have a composition ranging from about 50 to about 60 atomic percent tantalum and from about 40 to about 50 atomic percent aluminum. The resulting thin film heater 30 may have a composition ranging from about 10 to about 50 atomic percent tantalum, from about 10 to about 40 atomic percent aluminum, from about 30 to about 50 atomic percent nitrogen. The bulk resistivities of the thin film heaters 30 may range from about 1000 to about 4000 micro-ohms-cm. RF bias may be applied to the substrate to increase the film uniformity.

Suitable sputtering conditions are desired to produce a TaAlN heater 30 having the characteristics described above. A cluster sputtering device for reactive sputtering may be used. The substrate 16 may be heated to above room temperature, typically from about 150° to about 250° C. during the sputtering step. Also, the nitrogen to argon gas flow rate ratio, the sputtering power and the gas pressure are selected within relatively narrow ranges. In one exemplary process, the nitrogen to argon flow rate ratio may range from about 0.15:1 to about 0.35:1, the sputtering power may range from about 1 to about 10 kilowatts/m² and the pressure may range from about 5 to about 20 millitorrs. Suitable sputtering conditions for providing a TaAlN heaters 30 according to the exemplary embodiments and according to a conventional process are given in the following table.

TABLE 1

| | Total | N₂ | Ar | | | | Substrate | Deposition |
|---|---|---|---|---|---|---|---|---|
| Run | Flow | Flow | Flow | N₂/Ar | Power | Pressure | Temperature | Rate |
| No. | (sccm) | (sccm) | (sccm) | Ratio | (KW/m²) | (millitorr) | (° C.) | (Å/min) |
| 1 | 96 | 16 | 80 | 0.2 | 6.5 | 11 | 200 | 0.904 |
| 2 | 96 | 16 | 80 | 0.2 | 6.5 | 11 | 200 | 0.463 |
| 3 | 125 | 30 | 95 | 0.3 | 6.5 | 11 | 200 | 0.972 |
| 4 | 125 | 30 | 95 | 0.3 | 6.5 | 11 | 200 | 0.750 |
| 5 | 125 | 30 | 95 | 0.3 | 6.5 | 11 | 200 | 0.722 |
| 6 | 125 | 20 | 105 | 0.2 | 3.0 | 11 | 200 | 0.478 |
| 7 | 125 | 20 | 105 | 0.2 | 3.0 | 11 | 200 | 0.500 |
| 8 | 125 | 20 | 105 | 0.2 | 3.0 | 11 | 200 | 0.639 |

Runs 1 and 2 represent heaters made generally in accordance with U.S. Pat. No. 7,080,896, the disclosure of which is incorporated herein by reference. The heaters of Runs 1 and 2 had sheet resistance of 45 ohms/square. The heaters of Runs3-8 had sheet resistances of from about 100 ohms/square to about 600 ohms/square.

The heaters of Runs 3-8, made according to the foregoing process, may exhibit a relatively uniform sheet resistance over the surface area of the substrate 16 ranging from about 100 to about 600 ohms per square. The sheet resistance variations of the thin film heater 30 have standard deviation over the entire substrate surface of less than about 8 percent. The substantially uniform resistivity of the heaters 30 may significantly improve the quality of ejection heads 14 containing the heaters 30.

Unlike TaAlN resistors made by sputtering bulk tantalum and aluminum targets on room temperature substrates, such as described in U.S. Pat. No. 4,042,479 to Yamazaki et al., the thin film heaters 30 made according to the exemplary embodiments may be characterized as having a substantially nano-crystalline structure consisting essentially of AlN, TaN, and TaAl alloys. By using TaAlN as the material for the heater resistor 30, the layer providing the heater resistor 30 may be extended to provide an improved metal barrier layer for contacts to adjacent transistor devices and may also be used as a fuse material on the substrate 16 for memory devices and other applications.

Compositions of thin film heaters made according to a conventional process and according to the exemplary embodiments of Table 1 are given in the following table.

TABLE 2

| | Thickness | Nitrogen | Aluminum | Argon | Tantalum |
|---|---|---|---|---|---|
| Sample | (Angstroms) | (at %) | (at %) | (at %) | (at %) |
| 1 | <300 | 14.3 | 35.3 | 1.0 | 49.4 |
| 2 | <385 | 35.7 | 29.1 | 1.3 | 33.9 |
| 3 | <420 | 35.7 | 31.6 | 1.4 | 31.3 |
| 4 | <420 | 36.4 | 31.7 | 1.3 | 30.6 |
| 5 | <420 | 35.7 | 31.1 | 1.6 | 31.6 |

In Table 2, Sample 1 was made generally in accordance with Runs 1 and 2 of Table 1. Sample 2 was made generally in accordance with Runs 3 and 4 of Table 1. Samples 3-5 were made generally in accordance with Runs 7 and 8 of Table 1.

A benefit of the use of thin, high resistance TaAlN heaters made according to the exemplary embodiments is that the TaAlN layer used to provide the heaters may also provide a suitable barrier layer that substantially prevents Al/Si interdiffusion. The TaAlN heaters, as described herein, may be categorized as both a stuffed barrier and passive compound barrier layers for the following reasons: 1) TaAlN is amorphous, therefore, no fast diffusion path such as grain boundaries exist; 2) TaAlN is comprised of TaAl, TaN and AlN. TaN and AlN will not react with either Al or Si. It has been observed that the barrier characteristics of TaAlN may be proportional to the nitrogen doping concentration in the heater material, since more nitrogen concentration means more amorphous phase formation, and more TaAl may convert into inert TaN and AlN.

In order to demonstrate the barrier properties of the TaAlN heaters of the exemplary embodiments described above, an annealing experiment was conducted at 410° C. for 0 hr. 30 minutes and 1 hour on heaters made according to the Runs in Table 1. The heater of Run 2, having a thickness of 125 Angstroms failed to survive a normal CMOS process steps. Accordingly, there was device leakage of the heater of Run 2 even before the annealing step was conducted.

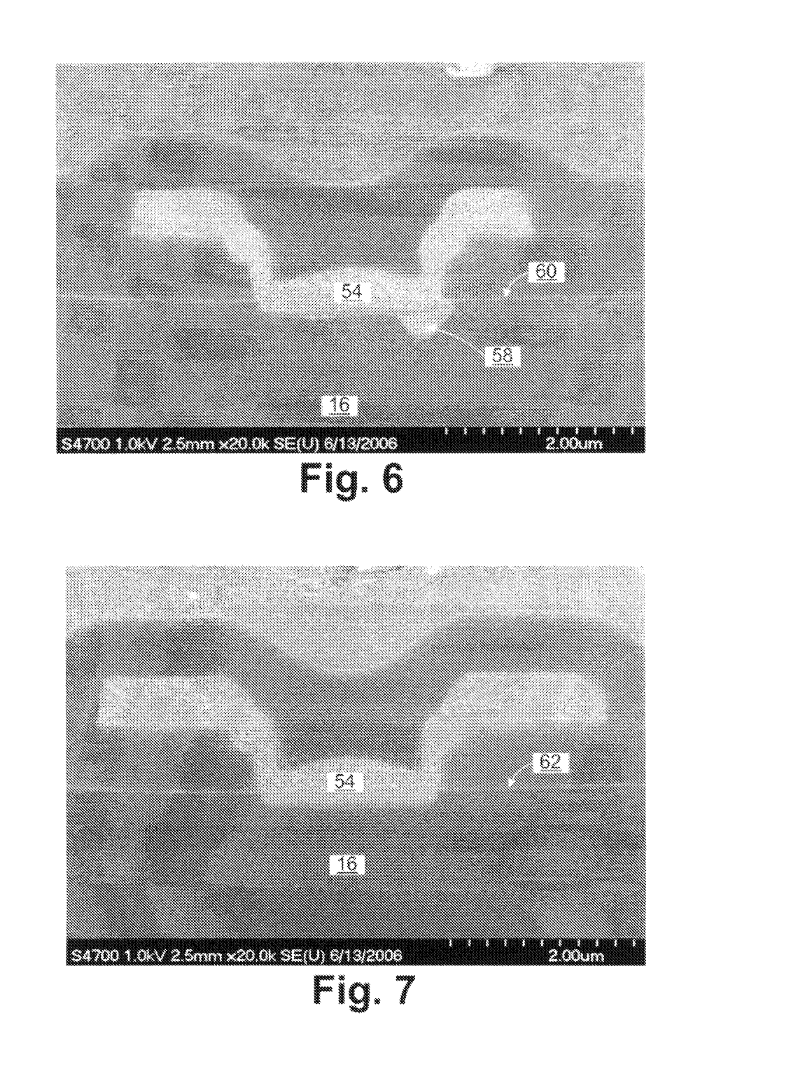

The heater or Run 1, having a thickness of 380 Angstroms showed improved barrier capability over the heater of Run 2, but still began showing device leakage after annealing at 410° C. for 1 hour. Device leakage of the heater of Run 1 was confirmed to be due to junction spiking as illustrated by the electromicrograph of FIG. 6. According to FIG. 6, an aluminum contact layer 54 is illustrated on a silicon substrate 56. The area 58 illustrates aluminum spiking of the silicon substrate 56 when the TaAlN barrier material 60 of Run 2 (Table 1) having a thickness of 125 Angstroms is used.

By contrast, medium and high bulk resistance TaAlN films according to the disclosed embodiments (Runs 3-8) did not show any device leakage after annealing at 410° C. for 1 hour over a range of heater thicknesses of 130 to 430 Angstroms. An electromicrograph of a heater of Run 5 having a thickness of 130 Angstroms providing a barrier layer 62 is illustrated in FIG. 7 wherein aluminum from the aluminum contact layer 54 did not diffuse into a silicon substrate 56.

The differences in barrier capability between a conventional TaAlN heater and a TaAlN heater having a medium or high bulk resistivity according to the disclosure may be understood by comparing the composition of Sample 1 in Table 2 with the composition of Samples 2-5. In Samples 2-5, the nitrogen concentration of the TaAlN heaters was about two and a half times higher than the nitrogen concentration of the TaAlN of Sample 1. Without desiring to be bound by theoretical considerations, it is believed that increasing the nitrogen concentration in the TaAlN heater improves the barrier capability of the heater layer.

Accordingly, medium/high bulk resistivity TaAlN films may have superior barrier capability compared to TaAl films, low bulk resistivity TaAlN films, and other traditionally used barrier films. Furthermore, the medium/high bulk resistivity TaAlN films may prevent Al junction spiking up to one hour at 410° C. even with a film thickness of less than 200 Angstroms. Conventional barrier layers typically require a thickness of greater than 800 Angstroms to provide the same barrier capability.

Since the heater layer, according to the exemplary embodiments provides both a resistive layer as well as a diffusion barrier layer between the Al layer and the substrate, fewer CMOS processing steps are required to provide ejection heads having the medium/high bulk resistivity TaAlN layers described herein.

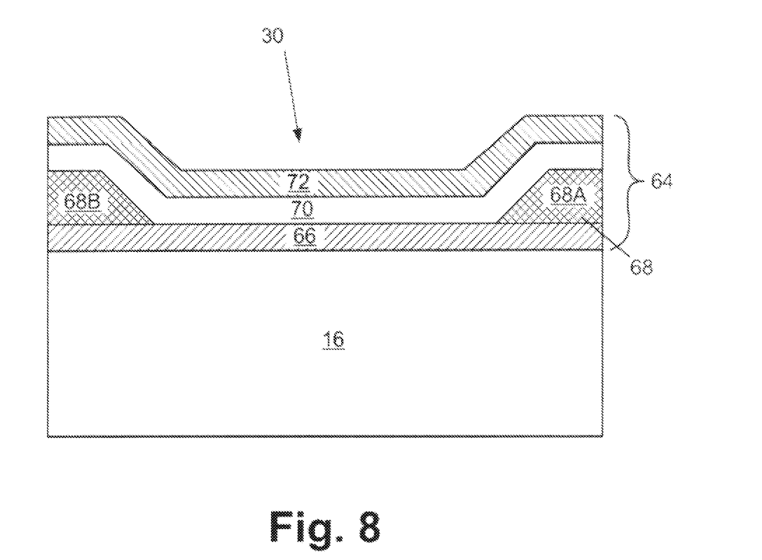

A more detailed illustration of a portion of an ejection head 14 showing an exemplary heater stack 64 including a heater 30 made according to the above described process is illustrated in FIG. 8. The heater stack 64 is provided on an insulated substrate 16. First layer 66 is the thin film resistor layer made of medium/high bulk resistivity TaAlN which is deposited on the substrate 16 according to the process described above.

After depositing the thin film resistive layer 66, a conductive layer 68, made of a conductive metal such as gold, aluminum, copper, and the like, is deposited on the thin film resistive layer 66. The conductive layer 68 may have any suitable thickness known to those skilled in the art, but typically has a thickness ranging from about 0.4 to about 0.6 microns. After deposition of the conductive layer 68, the conductive layer is etched to provide anode 68A and cathode 68B contacts to the resistive layer 66 and to define the heater resistor 30 therebetween the anode and cathode 68A and 68B.

A passivation layer or dielectric layer 70 may then be deposited on the heater resistor 30 and anode and cathode 68A and 68B. The layer 70 may be selected from diamond like carbon, doped diamond like carbon, silicon oxide, silicon oxynitride, silicon nitride, silicon carbide, and a combination of silicon nitride and silicon carbide. The passivation layer may have a thickness ranging from about 1000 to about 8000 Angstroms.

After depositing the passivation or dielectric layer 70, a cavitation layer 72 may be deposited and etched to cover the heater resistor 30. A particularly suitable cavitation layer 72 is tantalum having a thickness ranging from about from about 1000 to about 6000 Angstroms.

It is desirable to keep the passivation or dielectric layer 70 and cavitation layer 72 as thin as possible yet provide suitable protection for the heater resistor 30 from the corrosive and mechanical damage effects of the fluid being ejected. Thin layers 70 and 72 may reduce the overall thickness dimension of the heater stack 64 and provide reduced power requirements and increased efficiency for the heater resistor 30.

Once the cavitation layer 72 is deposited, this layer 72 and the underlying layer or layers 70 may be patterned and etched to provide protection of the heater 30. A second dielectric layer made of silicon dioxide is then deposited over the heater stack 64 and other surfaces of the substrate to provide insulation between subsequent metal layers that are deposited on the substrate for contact to the heater drivers and other devices.

At numerous places thoughout this specification, reference has been made to a number of U.S. Patents and publications. All such cited documents are expressly incorporated in full into this disclosure as if fully set forth herein.

The foregoing embodiments are susceptible to considerable variation in its practice. Accordingly, the embodiments are not intended to be limited to the specific exemplifications set forth hereinabove. Rather, the foregoing embodiments are within the spirit and scope of the appended claims, including the equivalents thereof available as a matter of law.

The patentees do not intend to dedicate any disclosed embodiments to the public, and to the extend any disclosed modifications or alterations may not literally fall within the scope of the claims, they are considered to be part hereof under the doctrine of equivalents.

What is claimed is:

1. A thin film heater for a micro-fluid ejection head comprising a tantalum-aluminum-nitride thin film material having a nano-crystalline structure consisting essentially of AlN, TaN, and TaAl alloys, wherein the thin film material has a sheet resistance ranging from about 100 to about 600 ohms per square, and a thickness ranging from about 100 to about 800 Angstroms.

2. The thin film heater of claim 1, wherein the thin film material has a bulk resistivity of from about 1000 to about 4000 μohm·cm.

3. The thin film heater of claim 1, wherein the thin film material comprises from about 10 to about 50 at. % tantalum, from about 10 to about 40 at. % aluminum and from about 30 to about 50 at. % nitrogen.

4. The thin film heater of claim 1, wherein the thin film material comprises a thin film layer made by a process of reactive sputtering a tantalum-aluminum alloy target in a nitrogen and argon containing atmosphere onto a substrate heated to a temperature ranging from about 100° to about 350° C.

5. The thin film heater of claim 1 wherein the thin film heater has a thickness ranging from about 200 to about 500 Angstroms.

6. A semiconductor substrate comprising a plurality of thin film heaters as set forth in claim 1.

7. A micro-fluid ejection head comprising the semiconductor substrate of claim 6.

8. The micro-fluid ejection head of claim 7, comprising a high density of thin film heaters ranging from about 6 to about 20 thin film heaters per square millimeter.

9. A method for making a micro-fluid ejection head for a micro-fluid ejection device, the method comprising:
depositing a thin film resistive layer adjacent to a surface of a substrate to provide a plurality of thin film heaters, the thin film resistive layer comprising a tantalum-aluminum-nitride thin film material having a nano-crystalline structure consisting essentially of AlN, TaN, and TaAl alloys, wherein the thin film material has a sheet resistance ranging from about 100 to about 600 ohms per square, a thickness ranging from about 100 to about 800 Angstroms, and a bulk resistivity of from about 1000 to about 4000 μohm·cm; and
defining anode and cathode conductors adjacent to the thin film heaters.

10. The method of claim 9, wherein the thin film resistive layer is deposited to provide a thin film material comprising from about 10 to about 50 at. % tantalum, from about 10 to about 40 at. % aluminum and from about 30 to about 50 at. % nitrogen.

11. The method of claim 9, wherein depositing the thin film material comprises reactive sputtering a tantalum-aluminum alloy target in a nitrogen and argon containing atmosphere onto a substrate heated to a temperature ranging from about 100° to about 350° C.

12. The method of claim 9, wherein the thin film resistive layer is deposited to a thickness ranging from about 200 to about 500 Angstroms.

13. A method for making a high resistance thin film resistor for a micro-fluid ejection head comprising:
heating a substrate to a temperature ranging from above about room temperature to about 350° C.;
reactive sputtering a tantalum aluminum alloy target containing from about 50 to about 60 atomic % tantalum and from about 40 to about 50 atomic % aluminum adjacent to a surface of the substrate;
providing a flow of nitrogen gas and a glow of argon gas during the sputtering wherein a flow rate ratio of nitrogen to argon ranges from about 0.1 to about 0.5; and
terminating the sputtering when the thin film resistor is deposited adjacent to the substrate has a thickness ranging from about 100 to about800 Angstroms;
wherein the thin film resistor comprises a TaAlN alloy containing from about 30 to about 50 at. % tantalum, from about 10 to about 40 at. % aluminum and from about 30 to about 50 at. % nitrogen, and the resistor has a bulk sheet resistance uniformity with respect to the substrate of less than about 8%.

14. The method of claim 13, wherein the sputtering is conducted with a power ranging from about 40 to about 200 kilowatts per square meter.

15. The method of claim 13, wherein the sputtering is conducted at a pressure ranging from about 1 to about 25 millitorrs.

16. The method of claim 13, wherein the temperature of the substrate during the sputtering ranges from about 100 to about 300° C.
